(19) United States
(12) Patent Application Publication
(10) Pub. No.: US 2006/0062329 A1
(43) Pub. Date: Mar. 23, 2006

(54) Apparatus and method for adaptive digital locking and soft evaluation of data symbols in a wireless digital communication system

(75) Inventor: Beng Huat Chua, Singapore (SG)

Correspondence Address: GEORGE O. SAILE, 28 DAVIS AVENUE, POUGHKEEPSIE, NY, 12603, US

(73) Assignee: Freesystems Pte., Ltd.

(21) Appl. No.: 11/231,231

(22) Filed: Sep. 20, 2005

Related U.S. Application Data
(60) Provisional application No. 60/612,008, filed on Sep. 22, 2004.

(51) Int. Cl. H04L 27/22; H04L 7/00

(52) U.S. Cl. 375/316; 375/355; 375/368

(57) ABSTRACT

A data communication system detects a synchronization signal and a start pattern, and extracts data symbols from a serially encoded digital data stream transmitted to a receiver. The communication system transmission apparatus that includes a frame formatter, which generates a frame of symbols of serially encoded data to be transmitted. The communication system has a receiving apparatus in communication with the transmission apparatus to acquire the series of symbols. The receiving apparatus has a register in communication with a sample and hold circuit to receive the series of symbols composed of a plurality of bits resulting from the sampling of the signal received by the sample and hold circuit. Upon receipt of the plurality of bits, location of the bits is adjusted within the register. A symbol evaluator is in communication with the register to examine the plurality of bits to determine a symbol value for the plurality of bits. The symbol value includes a synchronization value, a start value, and a data value. The synchronization value indicates the synchronization pattern indicating the timing of the signal. The start value indicates the start pattern at the beginning of the data message. The data value indicates at least one of the dual-bit data symbols of the data message. The symbol value is a most probable value of all possible symbol values.

### RELATED PATENT APPLICATIONS

This application claims priority to U.S. Provisional Patent Application Ser. No. 60/612,008, filed on Sep. 22, 2004, which is herein incorporated by reference.

“A Method and Apparatus for Ensuring High Quality Audio Playback in a Wireless or Wired Digital Audio Communication System,” Provisional U.S. Patent Application Ser. No. 60/612,007, Filing Date Sep. 22, 2004, assigned to the same assignee as this invention.

### BACKGROUND OF THE INVENTION

1. Field of the Invention

This invention relates to apparatus and methods for transmission and reception of digital data communication signals. More particularly, this invention relates to the synchronization of a receiver to received digital data communication signals, detection of start patterns within the digital data communication signals, and extraction of digital data messages from the digital communication signals.

2. Description of Related Art

Wireless transmission of digital data is often accomplished by sending serially formatted frames of the digital data. In systems such as that enumerated by the Infrared Data Association's IrDA “Serial Infrared Physical Layer Specification,” Version 1.4 May, 2001, the frame as shown in section 5.4.2 has a Preamble Field (PA), Start Flag Field (FA), a Data Field (DD), and a Stop Flag Field (STO). The receiver uses the Preamble Field to synchronize the clocking system of the receiver to the in coming message. Generally, a phase lock loop oscillator is used to synchronize the receiver to the Preamble Field.

Once the Preamble Field is detected and the receiver is synchronized, the receiver begins to detect the Start Flag Field to establish symbol synchronization. If the Start Flag Field is correct, the receiver then begins to interpret the data symbols of the Data Field and will continue to interpret the data symbols until the Stop Flag Field is received.

The specification details the encoding of the data in section 5.4.1. The digital data is transmitted using a four-pulse position modulation. In this instance a dual-bit data structure is encoded by positioning a pulse within a symbol. The symbol is divided into four time positions of the time duration of the symbol with each position representing the coding of the dual-bit data structure. The Preamble Field, the Start Flag Field, and the Stop Flag Field are each unique codes that have symbol streams that cannot be confused with the four-pulse position modulation of the dual-bit data structure.

The synchronization of the receiver employing a phase lock loop is subject to jitter in pulling the frequency of the local receiver to match the frequency of the transmitted data. Further any drift in the local oscillator causes the local oscillator to have to be re-locked periodically. Without periodic relocking of the local oscillator to the signal, there can be errors with the data reception. Further, multipath reception problems cause the received timing data to fluctuate with the differences in the delay of the paths.

U.S. Pat. No. 6,198,766 (Schuppe, et al.) provides a method and apparatus for adaptive pulse shaping by deciding if a pulse produced by a receiver to be sent to the demodulator should be lengthened (for instance by using an add operation) or shortened (e.g. by using a chop operation).

The pulse shaping logic is preferably adapted to use the preamble phase of a 4 Mbps PPM packet to determine the appropriate add or chop level required for the remainder data carrying portion of the packet.

U.S. Pat. No. 6,188,496 (Krishna, et al.) describes a wireless communication system having a repeater that has a receiver for receiving a signal and a clock generator for synchronization of the receiver to the received signal. The clock generator is generally a phase lock loop. A validation module determines whether a signature is present in the received signal. An invalidation module determines whether undesired signal components are present in the received signal. The received signal is transmitted if the signature is present and if the undesired signal components are not present.

U.S. Pat. No. 5,691,665 (Ohtani) teaches a pulse position modulated (PPM) demodulation device that has clock reproduction unit that provides a reproduced clock signal from a received PPM signal. The results of sampling the PPM signal with a reproduced clock signal are held by a sample result holding unit. Symbol synchronization is achieved from a received PPM signal by a symbol synchronizing signal generation unit. According to the sample result, the reproduced clock signal, and symbol synchronization, a reception data reproduction unit analyzes the result of a plurality of previous samples to decode reception data.

### SUMMARY OF THE INVENTION

An object of this invention is to detect a synchronization signal in a serially encoded digital data stream transmitted to a receiver.

Another object of this invention is to detect a start pattern embedded in a serially encoded digital data stream transmitted to a receiver.

Further, another object of this invention is to detect data symbols of a serially encoded digital data stream transmitted to a receiver.

To accomplish at least one of these objects and other objects, a data communication system has a transmission apparatus that includes a frame formatter, which generates a date frame of symbols of serially encoded digital data to be transmitted. The data frame includes a start pattern and the encoded data. The data frame is preceded by a synchronization signal. The synchronization signal indicates the frequency of the encoded data. The start pattern is a unique pattern of the frame denoting that the following data stream is valid digital data. The encoded data is four-pulse position modulated dual-bit data. Each frame of symbols is transferred from the frame formatter to a transmitter. The transmitter generates a signal composed of the series of symbols for broadcast to a transmission medium, such as the open atmosphere.

The communication system has a receiving apparatus in communication with the transmission apparatus to acquire the series of symbols. The receiving apparatus has a receiving amplifier to accept and condition the signal. The receiving apparatus has a sample and hold circuit to sample the signal at a frequency higher than the frequency of the four-pulse position modulation. The receiving apparatus has a register in communication with the receiver amplifier to receive the series of symbols composed of a plurality of bits resulting from the sampling of the signal received by the receiving apparatus and upon receipt of the plurality of bits, adjust location of the bits within the register.

A symbol evaluator is in communication with the register to examine the plurality of bits to determine a symbol value for the plurality of bits. The symbol value includes a synchronization value, a start value, and a data value. The synchronization value indicates the synchronization pattern indicating the timing of the signal. The start value indicates the start pattern at the beginning of the data message. The data value indicates at least one of the dual-bit data symbols of the data message. The symbol value is a most probable value of all possible symbol values.

The signal as received by the receiver and transferred to the register is composed of series of symbols. The first of the series of the series contains the synchronization signal, the second series contains the start pattern, and the third series forms the encoded data. The symbol evaluator examines the first series of symbols received by the register to establish synchronous lock with the signal. The symbol evaluator then examines a second series of symbols received by the register to determine the beginning of the data message. Finally, the symbol evaluator examines a third series of symbols received by the register to determine the data message.

The examining of the first series of symbols to establish synchronous lock begins by examining the plurality of bits in the register to determine that a first transition of a first symbol of the first series has occurred. Upon determining the first transition, the evaluator then inspects the plurality of bits resident in the register to determine if the plurality has a synchronization value. If the plurality of bits has a synchronization value, the evaluator iteratively assesses each of the subsequent symbols received by the register to determine that each of the symbols has a synchronization value. When each of the assessments determines that the subsequent symbols are a synchronization value, the receiver is locked. However, if the subsequent symbols are not a synchronization value, the evaluator must reestablish the initial transition of the first synchronization value.

The examining of the second series of symbols to determine the beginning of the data message consists of evaluating each of the second series of symbols received by the register to determine that each of the second series of symbols has a start value. If the second series of symbols has the start value, the beginning of the message is established. Alternately, if any of the second series of symbols is not the start value, the first series of symbols must be received and synchronous lock is again established.

The examining each symbol of the first, second, and third series of symbols to determine the symbol value of each symbol begins by assigning a first probability value for each of a plurality of subgroupings of bits that compose the symbol. The first probability value is indicative of a probability that the subgrouping of bits represents a first number of two binary numbers. A second probability value is then assigned for each of the plurality of subgroupings of bits that compose the symbol. The second probability value is indicative of a probability that the subgrouping of bits represents a second number of the two binary numbers. One probability value for each subgrouping that represents a digit of a symbol character of a symbol code employed in formation of the data message is selected. The probability values of the subgroupings are then summed to form a probability that the symbol represents each symbol character of the symbol code. The symbol character having the maximum probability that the symbol represents the symbol character of the symbol code is selected. The symbol is then assigned the symbol value of the symbol character to the symbol. The probability values are heuristically determined for each possible bit combination of the subgroupings of bits.

A second procedure for examining each symbol of the first, second, and third series of symbols to determine the symbol value each symbol begins by assigning one of the two binary numbers to a first sub-symbol of the symbol according to a maximum likelihood that the first sub-symbol is one of the two binary numbers. The assigning is iteratively performed until each subsequent sub-symbol is assigned one of the two binary numbers.

The data symbols are a four-pulse position modulation and the sampling of each digit of the four pulse position modulation form subgroupings of bits of the symbol. The sampling is at a sampling rate that is at least five times greater than a pulse position modulation clocking rate.

### BRIEF DESCRIPTION OF THE DRAWINGS

FIG. 1 is a block diagram of a communication system of this invention.

FIG. 2 is a plot of the relative timings for the timing of the four-pulse positioning modulation of the communication system of this invention.

FIG. 3 is a diagram of the frame format of the digital data of the communication system of this invention.

FIG. 4 is a diagram of the structure of the sampling of a signal acquired by the receiver of the communication system of this invention.

FIG. 5 is a chart of the probabilities assigned to possible symbol characters contained in the evaluation sub-windows of FIG. 4.

FIGS. 6a and 6b are flow charts of the method for establishing the pattern of the synchronization signal, the determination of the start pattern, and extraction of dual-bit data symbols of this invention.

FIG. 7 is flow chart for a first method for evaluating the most probable symbol of this invention.

FIG. 8 is a flow chart for a second method for evaluating the most probable symbol of this invention.

FIG. 9 is a flow chart for the evaluation of the pattern of the start pattern of this invention.

### DETAILED DESCRIPTION OF THE INVENTION

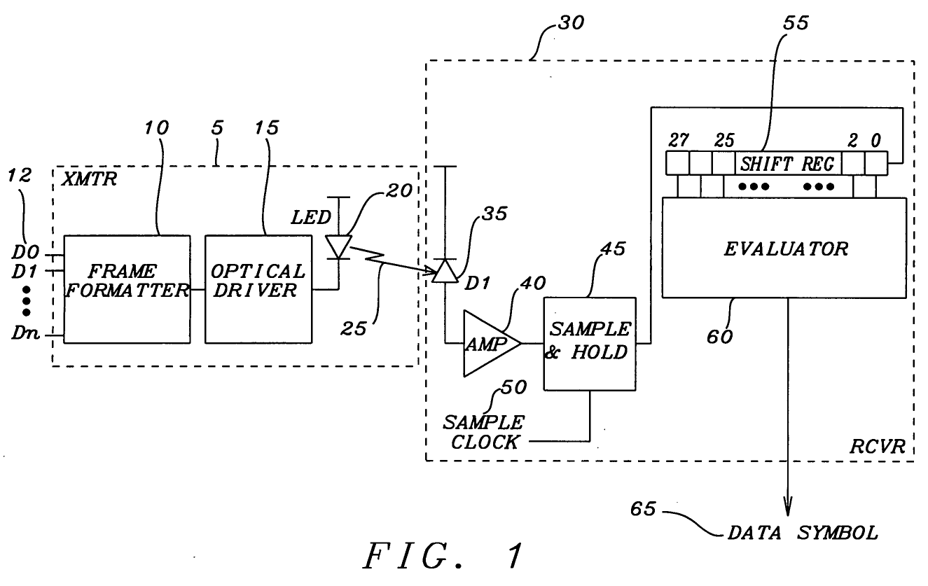

The digital data communication system of this invention, as shown in FIG. 1 has a transmitter 5. The transmitter has a formatter 10 that receives the digital data messages D0, D1, . . . , Dn 12 for dual-bit serialization. The frame formatter 10 then creates a four-pulse position modulation signal representing the encoded digital data messages D0, D1, . . . , Dn 12. The frame formatter 10 then concatenates a start pattern to the beginning of the data message.

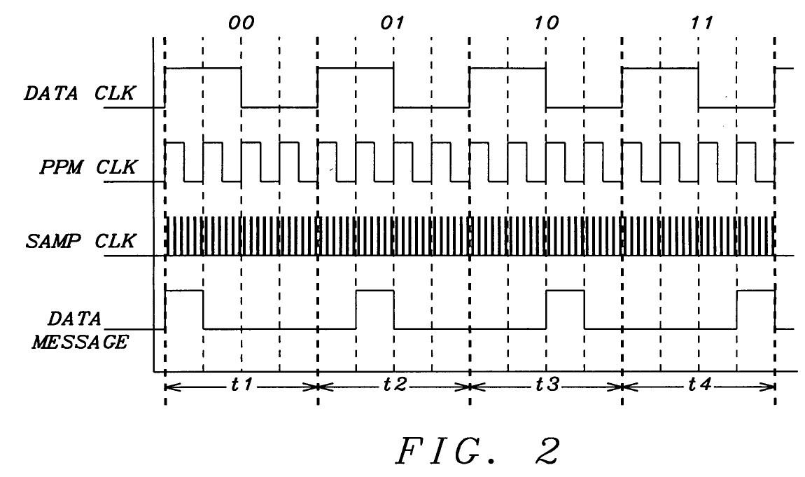

Referring to FIG. 2 for a discussion of the formation of the data message. The DATA CLOCK has the frequency rate that the digital data messages D0, D1, . . . , Dn 12 is gated to the frame formatter 10. The frame formatter has a modulation clock (PPM CLK) that is used to generate the four-pulse position modulated signal of the data message. The four-pulse position modulated signal of the data message illustrates the modulation of the four possible bit combinations of the dual-bit data and is explained as follows:

| Time Slot | Dual-Bit Code | PPM Encoding |
|---|---|---|
| t1 | 00 | 1000 |
| t2 | 01 | 0100 |
| t3 | 10 | 0010 |
| t4 | 11 | 0001 |

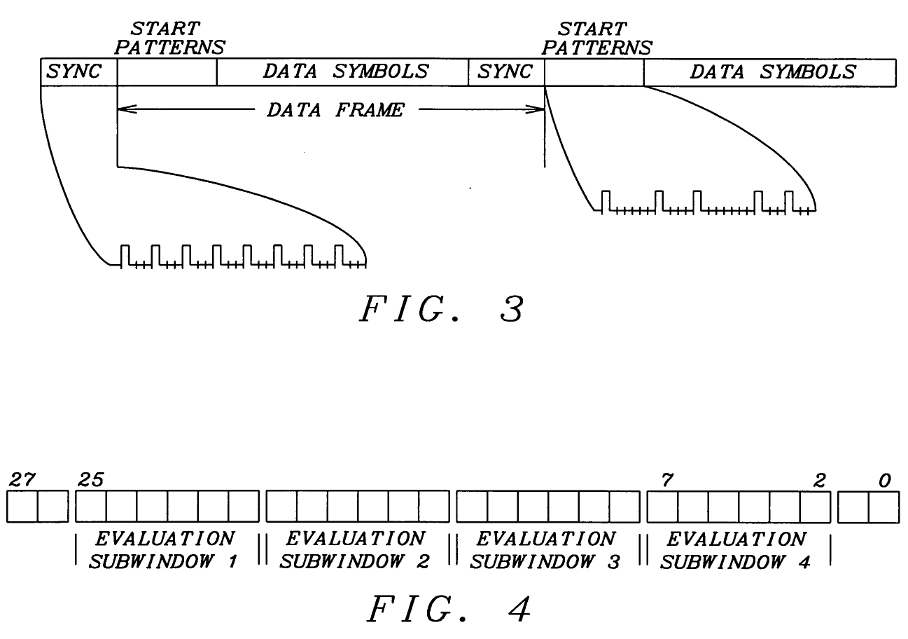

The structure of the frame is illustrated in FIG. 3. The data symbols of the data message are concatenated to the Start Patterns to form the Data Frame. The Synchronization pattern is the encoded dual-bit code 00 or the pattern (1000) transmitted repetitively (1000 1000 . . . ) until a Data frame is to be transmitted.

The Synchronization pattern (1000 1000 . . . ) is constantly transmitted prior to the Start patterns to enable the receiver 30 of FIG. 1 to align itself to the proper sampling position. The “1000” structure of the Synchronization pattern is crucial for the reception of the subsequent data symbols of the data message. The receiver 30 uses the “1” as the first reference bit for constructing the appropriate timing for the bit structure of the subsequent data symbols of the data message. The sequence of bits that formed a Start pattern has to be identified before a state machine within the receiver 30 proceeds to examine the next data field and the Start of the data frame.

The structure of the Synchronization pattern cannot be mistaken for data bits because the state machine of the receiver 30 examines the four-pulse position modulated signal for all the conditions that satisfy the recognition of the Start patterns and Start of the data frames. Once it is mathematically certain that it has the data frame in lock, the state machine of the receiver receives the data bits of the data symbols of the data message until the counter runs out and the data frame is completed. The state machine then exits and begins examining the received message for the Start patterns again.

Theoretically, the Synchronization pattern needs only one synchronization symbol (“1000”) to enable synchronization. The state machine of the receiver 30 evaluates the next 4 bit symbol after this synchronization symbol (“1000”) to identify if another synchronization symbol (“1000”) is received or the first symbol bits of the Start pattern are received. The first symbol of the Start pattern is chosen to be different from “1000” to enable the state machine of the receiver 30 to evaluate the four-pulse position modulated signal to identify the Start pattern. For Example, if the Start pattern is chosen to be 0100 0000 1000 0100 0100 0000 0100 0100, the state machine of the receiver 30 enable synchronization and identify the Start Pattern by evaluating following bit sequence:

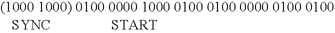

The Start Patterns are unique patterns of symbols that can never correctly represent data. The Start Patterns of symbols in the preferred embodiment of this invention is the symbol pattern (0100) (0000) (1000) (0100) (0100) (0000) (0100) (0100) as shown in FIG. 3. The data symbols are then formed and concatenated to the Start Patterns. Preferably, the data frame of data symbols of the data message has a fixed number of symbols to enable of the data message to be recovered. However, a form of variable length message can be implemented by adding a message between the Start patterns to inform the receiver 30 of the length of the incoming data message.

Once the data frame is formatted, the data frame and the synchronization signal are transferred from the frame formatter 10 to the optical driver 15. The optical driver 15 activates the light emitting diode (LED) 20 to transmit the frame data and the synchronization signal as a light signal 25. In the preferred embodiment, the light signal 25 is transmitted in the open air. The light signal 25 impinges upon the photodiode D1 35 incorporated in the receiver 30.

Light signal 25 is converted by the photodiode D1 35 to an electrical signal that is conditioned by the amplifier 40. The conditioned electrical signal is then transferred to the sample and hold circuit 45 which periodically samples and retains a portion of the conditioned electrical signal for evaluation to synchronize the receiver 30 to the transmitted data frame and synchronization signal to allow the receiver to extract the digital data message from the electrical signal.

The sampling clock 50 as shown in FIG. 2 (SAMP CLK) is a multiple of the four-pulse position modulation clock (PPM CLK). In the preferred embodiment the multiplication factor of the sampling clock 50 is approximately six. The multiplication factor maybe any convenient number, however, a multiplication factor as low as three time the four-pulse position modulation clock (PPM CLK) is not practical due to jitter in the transmitted data frame and synchronization pattern and due to multiple transmission paths of the light signal 25. The preferred factor of six is chosen since the four-pulse position modulation clock (PPM CLK) is approximately 4 MHz thus making the sampling rate 24 MHz, which a convenient design point. The practical minimum multiplication factor of the sampling clock 50 is approximately five and the practical maximum is determined by the physical characteristics of the components of the receiver.

The multiplication factor of the sampling clock 50 is not going to be exactly six. The difference in the multiplication factor causes the symbol boundaries to shift relative to the sampling clock 50 at some point. The maximum frame length is set by determining the available commercial crystal clocks tolerance and drift specifications. This ensures that under the worst case scenario, at most one clock cycle is added or subtracted to the receiver system at the end of the data message to ensure that the recovered data message is still correct.

The shifting of the Start pattern is insufficient to compensate for the long messages frequency drift effect because the problem manifests itself over time. And even if it does compensate for the short messages, the entire system will not be able to work because such a frequency shift will be too much to cause severe data corruption to the data message. There is very little chance for the receiver to predict the frequency drift at the locking stage. One of the methods to ensure a wide tolerance is to simultaneously acquire the data message using different lock positions to compensate for the symbol boundaries differences and to check the data integrities of the collected data messages. The data frame length is chosen and all the boundary conditions to ensure correct operation

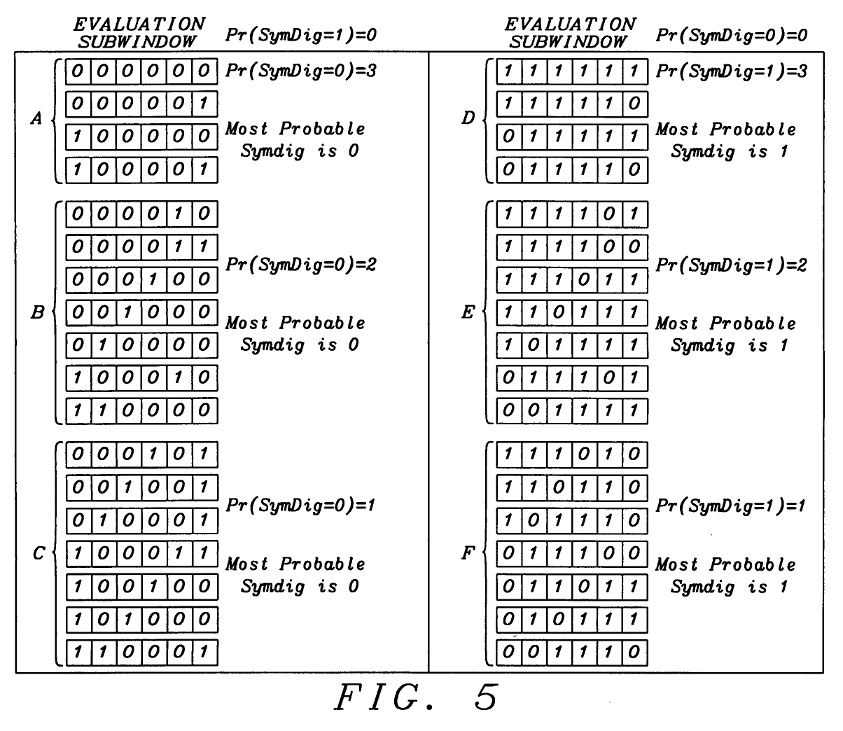

The sampled electrical signal is transferred to the shift register 55, which then evaluates samples for a full symbol of the synchronization signal, the start pattern, and a dual-bit data symbol. In the preferred embodiment the shift register 55 has twenty-eight (28) bit or samples of the electrical signal. An extra four samples are retained to allow for processing the samples such that samples maybe shifted within the shift register to insure correct synchronization, evaluation of the start pattern, and extraction of the dual-bit data symbols. All of the bits of the electrical signal retained by the shift register 55 are transferred to the symbol evaluator circuit 60. For the evaluation the contents of the shift register 55, the shift register contents are divided into sub-windows as shown in FIG. 4. The twenty-four (24) bits of that represent the symbol are divided into four six-bit evaluation sub-windows. The remaining four bits are the first two bits at the least significant register positions (0, 1) and the last two bits at the most significant register positions (26, 27). Each evaluation sub-window determines the symbol digit of four-pulse positioned modulated symbol.

A first series of the samples of the electrical symbols are examined by the evaluator circuit 60 to establish the presence of the synchronization symbols to lock the receiver 30 to the received electrical signal. A second series of the samples of the electrical symbols are examined by the evaluator circuit 60 to establish the presence of the start patterns indicating that the following third series of samples represent the symbols that are to be the symbols of the data message.

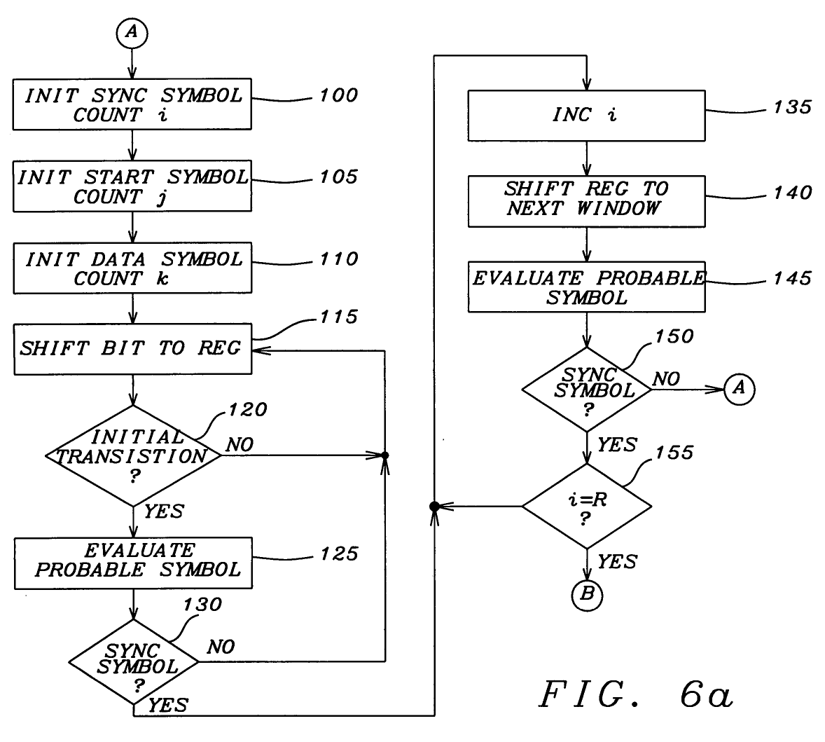

Determination of the symbol value for the samples for each symbol is based on the probability that the contents of a sub-window of the shift register 55 represent a symbol digit having a particular binary (0 or 1) value. Refer now to FIG. 5 for an explanation of the probability that the sampling of the electrical signal causes a particular pattern to be present in a sub-window of the shift register 55. The probabilities are weightings from zero (0) to three (3) with three being the highest probability and zero being an impossible occurrence. The Group A of sub-window contents has a probability weighting of three that they represent a symbol digit having a 0. The Group B of sub-window contents has a probability weighting of two that they represent a symbol digit having a 0. The Group C of sub-window contents has a probability weighting of one that they represent a symbol digit having a 0. The Groups A, B, and C have zero probability that they really represent a symbol digit having a binary 1.

The Group D of sub-window contents has a probability weighting of three that they represent a symbol digit having a 1. The Group E of sub-window contents has a probability weighting of two that they represent symbol digit having a 1. The Group F of sub-window contents has a probability weighting of one that they represent a symbol digit having a 1.

The Groups D, E, and F have zero probability that they really represent a symbol digit having a binary 0.

The chart, as shown in FIG. 5, contains 36 of the possible 64 binary combinations for each of the sub-windows of the shift register 55. The remaining 28 combinations are not likely to occur and therefore are assigned as a binary 0 and have a zero probability of being a 1. The probability weightings are heuristically chosen for all the combinations of symbol values. The probability weightings are derived based on the channel characteristics. For example it can be shown that the infrared channel contributes to extending of the “tail effect” of the transmitted signal. For example, a message with the bit sequence “00000 11111 000000 11111 00000” as transmitted can become at the receiver end the bit sequence “00000 11111 10000 11111 10000” or “00000 11111 11000 11111 11000”. Hence the probability weights in this example are assigned such that the bit sequence “10000” or “11000” with a higher probability of really being a “0000”.

The evaluation of the synchronization signal to establish the synchronization of the receiver to the transmitted light signal begins by determining the location of a first transition within the shift register. Once the transition is found each sub-window is evaluated to determine the synchronization symbol. Once the synchronization symbols are determined, the sub-windows are evaluated to determine the start pattern. Then upon receipt of the start pattern, each of the sub-windows is evaluated to determine the data symbols of the data message.

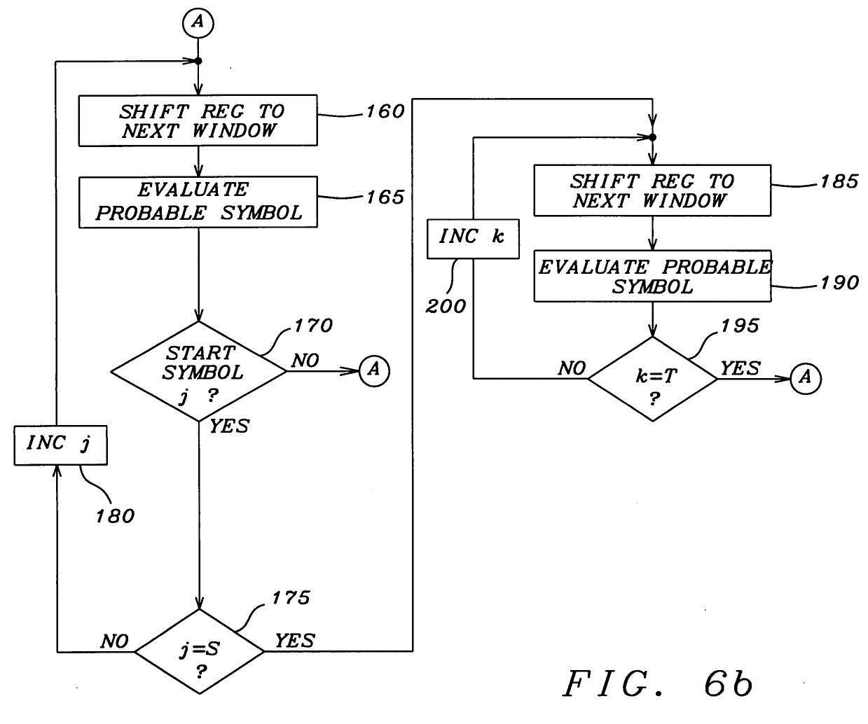

Refer now to FIGS. 6a and 6b for a more detailed discussion of the method for the determination of the synchronization signal, the determination start pattern, and the extraction of the data symbols. The Evaluator circuit 60 maintains three counter circuits (Sync Symbol Count i, Start Symbol Count j, and Data Symbol Count k) that are initialized (Boxes 100, 105, and 110) at the beginning of the method. The bits are shifted (Box 115) into the register 55 a single bit at a time. The high order bits (27, 26, and 25) are examined (Box 120) to determine if they contain a pattern (001) indicating an initial transition. If the pattern does not indicate the transition, the shift register is shifted (Box 115) one bit to the left, thus shifting a new bit to the bit 25. The new high order bits (27, 26, and 25) are examined (Box 120) again for the initial transition indicating the beginning of a transmission.

Upon receipt of the initial transition, the symbol contents of the shift register 55 are evaluated (Box 125) and the most likely symbol is determined. The determined symbol value of the shift register 55 is compared (Box 130) to the synchronization signal symbol. If it is not a synchronization symbol, the shift register 55 is shifted (Box 115) to determine the initial transition and upon receipt of a new initial transition, evaluating (Box 125) the symbol value of the contents of the shift register 55. If at the comparison (Box 130) of the symbol value of the contents of the shift register 55 with the synchronization signal symbol, the symbol value of the contents of the shift register 55 is a synchronization symbol, the synchronization symbol counter (i) is incremented (Box 135). The shift register 55 is shifted (Box 140) for such that a new complete window is present in the window. The contents of the shift register 55 are evaluated (Box 145) for the most probable symbol. The symbol value of the contents of the shift register 55 is compared (Box 150) to the synchronization symbol value. If the symbol value of the contents of the shift register 55 is not the synchronization value an error has occurred and the method is restarted. However, if the symbol value of the contents of the shift register 55 is that of a synchronization symbol, the synchronization symbol count value (i) is compared (Box 155) with the number of synchronization values (R) required to achieve synchronization with the incoming signal . If all the synchronization symbol values have not been determined, the synchronization symbol counter (i) is incremented (Box 135), the shift register is shifted (Box 140) to the next full window of samples, and the symbol value of the contents of the shift register 55 are evaluated (Box 145). As mentioned above, theoretically one Synchronization symbol is required for locking. But for optimal system performance, there is a requirement to employ the unused bandwidth by continuously transmitting the Synchronization symbols to ensure that the receiver 30 is tightly locked to the incoming data symbols of the data message.

When the correct number (R) of synchronization symbols is determined, the shift register is shifted (Box 160) to the next full window of samples. The contents of the shift register 55 are evaluated to determine (Box 165) the probable symbol value. The probable symbol value of the contents of the shift register is compared (Box 170) with the start symbol pattern of the current start symbol (j). As described above the start symbol is a unique pattern that is not replicated in the data message. If the symbol value of the contents of the shift register 55 is not the appropriate symbol value, the method is completely restarted with the search for the initial transition. However, if the symbol value is the correct start symbol pattern, the start symbol counter (j) is compared to the number of symbols in the start symbol pattern. If the complete start symbol pattern has not been received, the start symbol counter (j) is incremented (Box 180), shift register shifted (Box 160) to the next window, the contents of the shift register are evaluated (Box 165) for the probable symbol, and the evaluated symbol value is compared to the current start symbol of the sequence of start symbols. This process continues until the start symbol counter indicates that number of start symbol values have been evaluated.

Upon successful detection of the complete start symbol pattern, the next complete window is shifted (Box 185) to the shift register 55. The symbol value of the contents of the shift register 55 is evaluated (Box 190) and the data symbol of the data message is extracted. The data symbol counter (k) is compared to the number of symbols (T) included in a data message of a data frame. If the complete data message is not extracted, the data symbol counter (k) is incremented (Box 200), the shifter register 55 is shifted (Box 190) to receive the next full window of data, and the contents of the shift register 55 are evaluated (Box 190) to extract the data symbol value of the current data symbol. When all the data symbol values are evaluated and the data extracted, the method begins again to determine the beginning of the next synchronization symbols for the next data frame.

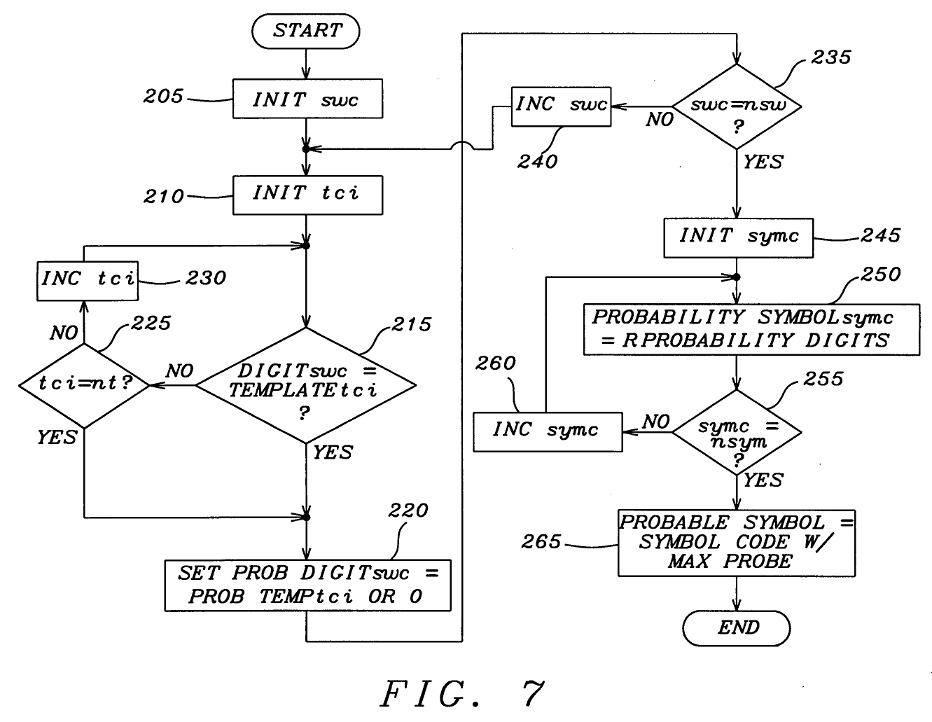

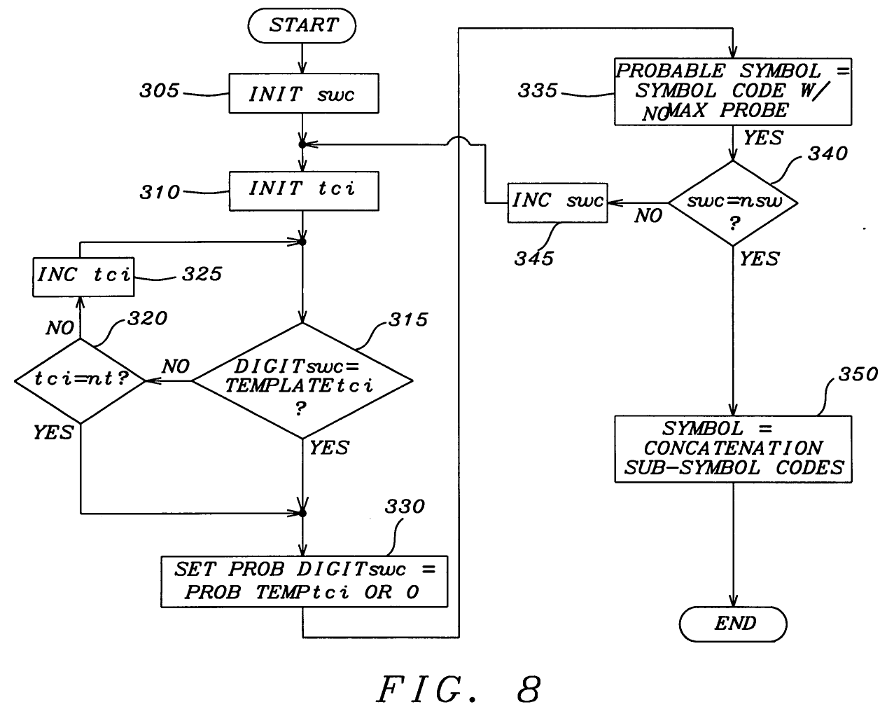

The evaluation of the probable symbol as described in FIGS. 6a and 6b are accomplished in two methods as shown in FIGS. 7 and 8. The two methods maybe executed separately or maybe executed simultaneously with one method acting as a verification of the results of the other. In FIG. 7, the contents of the shift register 55 are examined and the probability that the sub-windows have a certain contents is ascertained. The probabilities of the sub-windows are summed and the probable symbol is assigned the symbol value with the maximum probability.

If both methods two methods as shown in FIGS. 7 and 8 are used together to determine a symbol value and they do not agree, the symbol value can be mathematically determined based on maximal probability. The methods are used to make intelligent guesses of the most probable symbol value, not to ascertain the correct symbol value. When subjected to a noisy channel environment and if the methods cannot make sense of any decent symbols from the incoming stream, then it will be unable to lock onto the data stream. Further, the Start patterns and the embedded control data outside the data message have checksums to ensure their data integrity.

Refer now to FIG. 7 for a more detailed description of the first method for determining the symbol value using the maximum probability that the symbol value is equal to a certain coding. The method begins with initializing (Box 205) a sub-window counter (swc) within the evaluator circuit 60. The sub-window counter (swc) counts the number of symbol digits that for the symbol of the data message. In the example of the four-pulse positioned modulation, the number of symbol digits is four. For this embodiment the sub-window counter is set to zero and incremented to four.

The template index counter (tci) is then initialized (Box 210). The template index counter (tci) counts the number of templates for which the probabilities are known. In the case of the preferred embodiment there are thirty-six (36) templates with non-zero probabilities. Only these need to be examined to determine the probability that they are either binary 0 or 1. The template index counter (tci) then needs to track only 36 evaluations.

The sub-window indicated by the sub-window counter (swi) is compared (Box 215) to the template indicated by the template index counter (tci). If the sub-window is not equal to the template the template index counter (tci) is compared (Box 225) with the number of templates. If all templates have not been examined the template index counter (tci) is incremented (Box 230) and the sub-window is compared (Box 215) to the next template. This is continued until the sub-window is equal to one of the templates or all templates have been examined.

If the sub-window is equal to one of the templates, the probabilities for the sub window are assigned (Box 220) for the template as explained for FIG. 5. For example if the sub-window has a probability 2 that it is a binary 0 and a probability 0 that it is a probability 1, the probability of the sub-window is assigned (Box 220) a 2 for the value 0 and a 0 for the value 1. If the sub-window does not contain any of the template values, then the probability for the window is assigned a zero for either value and the symbol digit is assigned either a 0 value or a 1 value. The assignment is arbitrary to assign a zero of a one value, since the symbol value is meaningless here. It does not make any difference whether it is a one or zero, because it is not going to help in the locking process. In the system design however, the number of transmitted ones is less than the number of transmitted zeroes, therefore from the system point of view, it is better to assign a 0 to a symbol that failed the template test.

The sub-window counter (swc) is compared (Box 235) with the number of sub-windows in a symbol. If all the sub-windows have not been evaluated for their template probabilities, the steps are repeated until all the probabilities for the sub-windows are assigned. The symbol counter (symc) is initialized (Box 245). The symbol counter (symc) indicated the total number of symbols in the possible coding of the symbol. In the instance of the four-pulse positioned modulated symbol there are four possible employed for data symbols. The synchronization symbol is the data symbol 00 and needs to be examined for the single symbol. The start pattern is unique and needs to be examined for each separate specific pattern.

The probability that the contents of the shift register 55 is then calculated (Box 250) as the sum of the probability that each sub window equals a symbol digit of the symbol. That is represented as the formula:
Pr(Sym=n₁n₂n₃,n₅)=Pr(n₁)+Pr(n₂)+Pr(n₃)+Pr(n₄)
where:

n₁, n₂, n₃, n₅ are the symbol digits a specified by the template,

In the four-pulse positioned modulation, as described above, the possible symbols are for 1000, 0100, 0010, and 0001 and the probabilities for each symbol are determined.

The symbol counter is compared (Box 255) to the number of symbols (nsym). If all symbols have not been calculated (Box 250), then the symbol counter is incremented (Box 260) and the probability is calculated (Box 250). When all the potential symbol probabilities are calculated (Box 250), the symbol is assigned (Box 265) the symbol value of symbol code with the maximum probability.

The second method for determining the symbol value for the contents of the shift register is accomplished by selecting the most likely symbol digit for each digit and assigning it to the symbol digit position. There is no validation that ultimate symbol is a valid digit using this method solely. Refer now to FIG. 8 for a discussion of the second method. As described in FIG. 7 the sub-window counter (swc) is initialized (Box 305) and the template counter (tci) is initialized (Box 310). The sub-window is compared (Box 315) to the template value. If the sub-window is not equal to the template value, the template is compared (Box 320) to the number of templates (nt). If all the templates have not been examined, the sub-window is then compared (Box 315) to the next template. When the sub-window is equal to the template value, the probability assignment for the template is assigned (Box 310) to the probability of the symbol digit of the sub-window. If all templates are examined and the sub-window is not equal to any of the templates, then the sub-window is assigned a value of a binary zero. The probability will be assigned a zero, thus indicating an error.

The sub-window is assigned (Box 335) a symbol digit value that is the maximum probability for the binary digit. The sub-window counter (swc) is compared (Box 340) to the number of sub-windows (nsw). If all the sub-windows have not been examined the sub-window counter (swc) is incremented (Box 345) and the next probable symbol digit value is determined. When all the symbol digit values are determined, the symbols is assigned (Box 350) as the concatenation of the sub-symbol digit value coding.

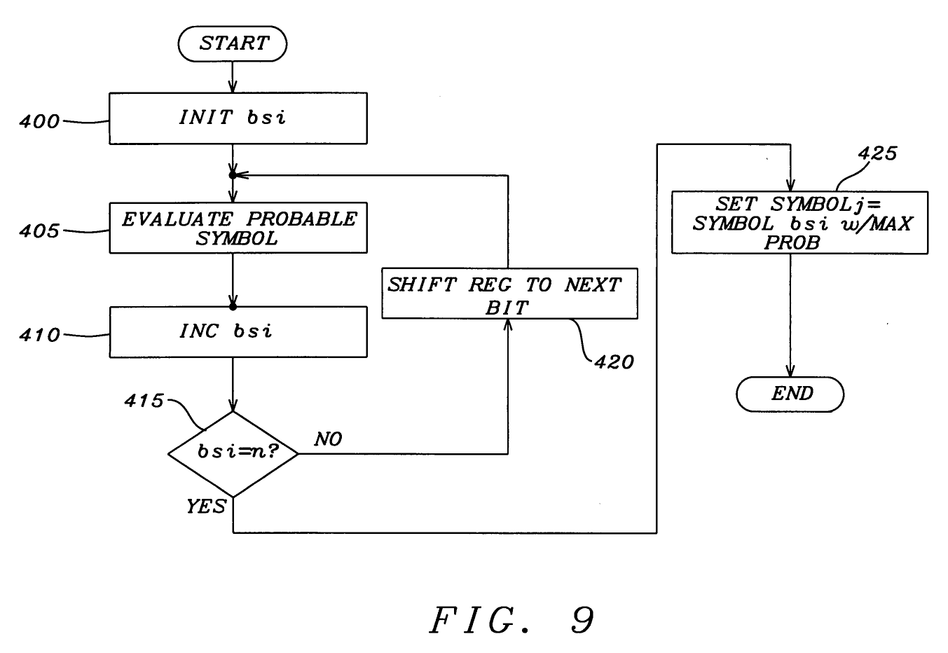

The evaluation of the probable start symbol of the start pattern 165 of FIG. 6b is shown as the method of FIG. 9. The evaluation of the start pattern begins with initializing (Box 400) the bit shift index (bsi). The shift register 55 is to be shifted a single bit at a time for a number of bits and the contents evaluated for the current symbol of the start pattern to insure detection of the start pattern. The bit shift index (bsi) is a counter within the evaluator 60 that is used to control the number of shifts used to determine the current start pattern.

The contents of the shift register 55 are evaluated (Box 405) according to the methods as described in FIGS. 7 and/or 8 to determine whether the current symbol of the start pattern is present. The probability that the contents of the shift register 55 is the correct symbol of the start patter is recorded and retained for further evaluation. The bit shift index (bsi) is incremented (Box 410) and the bit shift index (bsi) is compared (Box 415) to the number (n) of shifts allocated for the evaluation of the symbols of the start pattern. If the shift register 55 has not been shifted for the number (n) of shifts, the shift register is displaced by one bit. The new contents of the shift register 55 are now evaluated (Box 405) and the probability of that the symbol is the correct symbol of the start pattern is recorded and retained for further evaluation. The bit shift index (bsi) is again indexed (Box 410). This continued until the number (n) of shifts is completed. In the preferred embodiment this number (n) of shifts is three.

When the final shift is completed, the current start symbol (j) is assigned the symbol detected during each change of the shift register 55 having the maximum probability of being correct. The method of detection is thus completed and the detected symbol is compared (Box 170 of FIG. 6b) to the current start symbol value and the start pattern verification continues.

The shifting of the data symbols during the locking process obtains the most probable locking position before the data message acquisition. It evaluates the probability weights at the −1, 0 and +1 position with respect to the sampling clock and chooses the position with the highest probability evaluation number. Such a method is to ensure mathematically that the incoming data message is locked correctly and all acquired data bits are have the highest probability of being correct. For example, if a transmitter transmits data pulses at a data rate of 200 ns and three receivers reproduce the data pulses at a data rate of 200 ns, 230 ns and 170 ns, due to the spread of the production process. The methods as described above are able to manage such changes in the data pulse width deviation as it is based on probabilities and to ensure with maximal effort that the data message stream is locked at the central pulse position. If the locking position is fixed, ignoring the probability weights, then the receivers with the 170 ns and the 230 ns will fail.

The method as described has a fixed frame length format. There is a limit to the length of the data frame due to the speed differences in the transmitter and receiver sampling clock. Hence a longer data frame has the problem of second half of the data frame data easily corrupted if the transmitter and receiver sampling clock differs by some calculated margins. Such a sampling clock mechanism works best if the transmitter and receiver clocks are almost exact. If a variable length frame were to be implemented, some control data bits have to be embedded in the Start patterns, as described above, to inform the receiver of the data type and message length. In this way, the receiver is able to adapt by setting the data counter to collect the number of data bits as the data message is received.

The shift register 55 and the evaluator circuit 60 are shown as separate and distinct circuits. They may be such as implemented in an application specific integrated circuit (ASIC) or methods for synchronization, detection of a start pattern, and extraction of data maybe implemented as program process within a digital signal processor. The methods as described in FIGS. 6a, 6b, 7, 8, and 9 would be program code retained in media such as a read only memory (ROM), an electro-optical disk or a magnetic disk and executed by the digital signal processor.

While this invention has been particularly shown and described with reference to the preferred embodiments thereof, it will be understood by those skilled in the art that various changes in form and details may be made without departing from the spirit and scope of the invention.

The invention claimed is:

1. A digital communication receiver comprising:
a register in communication with telemetric device to receive series of symbols composed of a plurality of bits resulting from a sampling of a signal received by said digital communication receiver and upon receipt of said plurality of bits, adjust location of said bits within said register; and
a symbol evaluator in communication with said register to examine said plurality of bits to determine a symbol value for said plurality of bits, said symbol value including a synchronization value indicating a timing of said signal, a start value indicating a beginning of a data message, and a data value indicating at least one data bit of said data message, wherein said symbol value being a most probable value of all possible symbol values.

2. The receiver of claim 1 wherein said evaluator executes the steps of:
examining a first series of symbols received by said register to establish synchronous lock with said signal;
examining a second series of symbols received by said register to determine the beginning of the data message; and
examining a third series of symbols received by said register to determine the data message.

3. The receiver of claim 2 wherein examining the first series of symbols to establish synchronous lock comprises the steps of:
a) examining the plurality of bits in said register to determine a first transition of a first symbol of said first series;
b) upon determining the first transition, evaluating said plurality of bits resident in said register to determine if said plurality has a synchronization value;
c) if said plurality of bits has a synchronization value, iteratively evaluating each of the subsequent symbols received by said register to determine that each of said symbols has a synchronization value;
wherein, if the iterative evaluating of each of the subsequent symbols is a synchronization value, the receiver is locked; and
wherein, if the iterative receiving and evaluating of any of the pluralities of bits is not a synchronization value, iterating steps a)-c) until the receiver is locked.

4. The receiver of claim 2 wherein examining the second series of symbols to determine the beginning of the data message comprises the steps of: evaluating each of the second series of symbols received by said register to determine that each of said second series of symbols has a start value;
wherein, if any of said second series of symbols does not have the start value, evaluating said series of symbols received by said register to determine that the first series of symbols is received to again establish synchronous lock;
wherein, if the second series of symbols have the start value, the beginning of the message is established.

5. The receiver of claim 2 wherein the examining each symbol of the first, second, and third series of symbols to determine the symbol value of each symbol comprises the steps of:
assigning a first probability value for each of a plurality of subgroupings of bits that compose the symbol, said first probability value indicative of a probability that the subgrouping of bits represents a first number of two binary numbers;
assigning a second probability value for each of the plurality of subgroupings of bits that compose the symbol, said second probability value indicative of a probability that the subgrouping of bits represents a second number of the two binary numbers;
selecting one probability value for each subgrouping that represents a digit of a symbol character of a symbol code employed in formation of the data message;
summing the probability values of the subgroupings to form a probability that the symbol represents each symbol character of the symbol code;
selecting the symbol character having the maximum probability that the symbol represents said symbol character of the symbol code; and
assigning the symbol value of said symbol character to the symbol.

6. The receiver of claim 5 wherein the first and second probability values are heuristically determined for each possible bit combination of the subgroupings of bits.

7. The receiver of claim 2 wherein the examining each symbol of the first, second, and third series of symbols to determine the symbol value each symbol comprises the steps of:
assigning one of the two binary numbers to a first sub-symbol of the symbol according to a maximum likelihood that said first sub-symbol is one of the two binary numbers; and
iteratively performing said assigning until each subsequent sub-symbol is assigned one of the two binary numbers.

8. The receiver of claim 1 wherein the symbols are a four pulse position modulation.

9. The receiver of claim 8 wherein sampling of each digit of the four pulse position modulation form subgroupings of bits of the symbol.

10. The receiver of claim 9 wherein said sampling is at a sampling rate that is at least five times greater than a pulse position modulation clocking rate.

11. A data communication system comprising:
a transmission apparatus including:
a frame formatter to encode digital data into series of symbols;
a transmitter in communication with the frame formatter to receive the series of symbols and transmit a signal composed of the series of symbols; and
a receiving apparatus in communication with said transmission apparatus to acquire said series of symbols, said receiving apparatus including:
a receiving amplifier to accept and condition said signal
a sample and hold circuit to sample said signal;
a register in communication with the sample and hold circuit to receive the series of symbols composed of a plurality of bits resulting from the sampling of the signal received by said receiver apparatus and upon receipt of said plurality of bits, adjust location of said bits within said register; and
a symbol evaluator in communication with said register to examine said plurality of bits to determine a symbol value for said plurality of bits, said symbol value including a synchronization value indicating a timing of said signal, a start value indicating a beginning of a data message, and a data value indicating at least one data bit of said data message, wherein said symbol value being a most probable value of all possible symbol values.

12. The data communication system of claim 11 wherein said evaluator executes the steps of:
examining a first series of symbols received by said register to establish synchronous lock with said signal;
examining a second series of symbols received by said register to determine the beginning of the data message; and
examining a third series of symbols received by said register to determine the data message.

13. The data communication system of claim 12 wherein examining the first series of symbols to establish synchronous lock comprises the steps of:
a) examining the plurality of bits in said register to determine a first transition of a first symbol of said first series;
b) upon determining the first transition, evaluating said plurality of bits resident in said register to determine if said plurality has a synchronization value;
c) if said plurality of bits has a synchronization value, iteratively evaluating each of the subsequent symbols received by said register to determine that each of said symbols has a synchronization value;
wherein, if the iterative evaluating of each of the subsequent symbols is a synchronization value, the receiver is locked; and
wherein, if the iterative evaluating of any of the pluralities of bits is not a synchronization value, iterating steps a)-c) until the receiver is locked.

14. The data communication system of claim 12 wherein examining the second series of symbols to determine the beginning of the data message comprises the steps of:
evaluating each of the second series of symbols received by said register to determine that each of said second series of symbols has a start value;
wherein, if any of said second series of symbols does not have the start value, evaluating said series of symbols received by said register to determine that the first series of symbols is received to again establish synchronous lock;
wherein, if the second series of symbols have the start value, the beginning of the message is established.

15. The data communication system of claim 12 wherein the examining each symbol of the first, second, and third series of symbols to determine the symbol value of each symbol comprises the steps of:
assigning a first probability value for each of a plurality of subgroupings of bits that compose the symbol, said first probability value indicative of a probability that the subgrouping of bits represents a first number of two binary numbers;
assigning a second probability value for each of the plurality of subgroupings of bits that compose the symbol, said second probability value indicative of a probability that the subgrouping of bits represents a second number of the two binary numbers;
selecting one probability value of the first and second probability values for each subgrouping that represents a digit of a symbol character of a symbol code employed in formation of the data message;
summing the probability values of the subgroupings to form a probability that the symbol represents each symbol character of the symbol code;
selecting the symbol character having the maximum probability that the symbol represents said symbol character of the symbol code; and
assigning the symbol value of said symbol character to the symbol.

16. The data communication system of claim 15 wherein the first and second probability values are heuristically determined for each possible bit combination of the subgroupings of bits.

17. The data communication system of claim 12 wherein the examining each symbol of the first, second, and third series of symbols to determine the symbol value each symbol comprises the steps of:
assigning one of the two binary numbers to a first sub-symbol of the symbol according to a maximum likelihood that said first sub-symbol is one of the two binary numbers; and
iteratively performing said assigning until each subsequent sub-symbol is assigned one of the two binary numbers.

18. The data communication system of claim 11 wherein the symbols are a four pulse position modulation.

19. The data communication system of claim 18 wherein sampling of each digit of the four pulse position modulation form subgroupings of bits of the symbol.

20. The data communication system of claim 19 wherein said sampling is at a sampling rate that is at least five times greater than a pulse position modulation clocking rate.

21. A synchronization apparatus within a digital communication receiver comprising:
a register in communication with telemetric device to receive series of symbols composed of a plurality of bits resulting from a sampling of a signal received by said digital communication receiver and upon receipt of said plurality of bits, adjust location of said bits within said register; and
a symbol evaluator in communication with said register to examine said plurality of bits to determine a synchronization symbol value for said plurality of bits wherein said synchronization symbol value being a most probable value of all possible symbol values and wherein upon receipt of a series of said symbols each having the synchronization symbol value, said communication receiver has established symbol lock.

22. The synchronization apparatus of claim 21 wherein examining the series of symbols to establish synchronous lock comprises the steps of:
a) examining the plurality of bits in said register to determine a first transition of a first symbol of said first series;
b) upon determining the first transition, evaluating said plurality of bits resident in said register to determine if said plurality has a synchronization value;
c) if said plurality of bits has a synchronization value, iteratively evaluating each of the subsequent symbols received by said register to determine that each of said symbols has a synchronization value;
wherein, if the iterative evaluating of each of the subsequent symbols is a synchronization value, the receiver is locked; and
wherein, if the iterative evaluating of any of the pluralities of bits is not a synchronization value, iterating steps a)-c) until the receiver is locked.

23. The synchronization apparatus of claim 22 wherein the examining each symbol series of symbols to determine the synchronization symbol value of each symbol comprises the steps of:
assigning a first probability value for each of a plurality of subgroupings of bits that compose the symbol, said first probability value indicative of a probability that the subgrouping of bits represents a first number of two binary numbers;
assigning a second probability value for each of the plurality of subgroupings of bits that compose the symbol, said second probability value indicative of a probability that the subgrouping of bits represents a second number of the two binary numbers;
selecting one probability value of the first and second probability values for each subgrouping that represents a digit of a symbol character of a symbol code employed in formation of the data message;
summing the probability values of the subgroupings to form a probability that the symbol represents each symbol character of the symbol code;
selecting the symbol character having the maximum probability that the symbol represents said symbol character of the symbol code; and
assigning the symbol value of said symbol character to the symbol.

24. The synchronization apparatus of claim 23 wherein the first and second probability values are heuristically determined for each possible bit combination of the subgroupings of bits.

25. The synchronization apparatus of claim 22 wherein the examining each symbol of the series of synchronization symbols to determine the symbol value each symbol comprises the steps of:
assigning one of the two binary numbers to a first sub-symbol of the symbol according to a maximum likelihood that said first sub-symbol is one of the two binary numbers; and
iteratively performing said assigning until each subsequent sub-symbol is assigned one of the two binary numbers.

26. The synchronization apparatus of claim 21 wherein the symbols are a four pulse position modulation.

27. The synchronization apparatus of claim 26 wherein sampling of each digit of the four pulse position modulation form subgroupings of bits of the symbol.

28. The synchronization apparatus of claim 27 wherein said sampling is at a sampling rate that is at least five times greater than a pulse position modulation clocking rate.

29. A start pattern determination apparatus within digital communication receiver to determine a start pattern indicating a beginning of a message within a signal received by said digital communication receiver, said apparatus comprising:
a register in communication with telemetric device to receive series of symbols composed of a plurality of bits resulting from a sampling of a signal received by said digital communication receiver and upon receipt of said plurality of bits, adjust location of said bits within said register; and
a symbol evaluator in communication with said register to examine said plurality of bits to determine a start value for said plurality of bits, said start value indicating a beginning of a data message, wherein said start value being a most probable value of all possible symbol values.

30. The start pattern determination apparatus of claim 29 wherein examining the second series of symbols to determine the beginning of the data message comprises the steps of:
evaluating each of said series of symbols received by said register to determine that each of said series of symbols has a start value;
wherein, if any of said second series of symbols is not the start value, evaluating said series of symbols received by said register to establish a synchronous lock;
wherein, if the second series of symbols have the start value, the beginning of the message is established.

31. The start pattern determination apparatus of claim 30 wherein the examining each symbol of the series of symbols to determine the symbol value of each symbol comprises the steps of:
assigning a first probability value for each of a plurality of subgroupings of bits that compose the symbol, said first probability value indicative of a probability that the subgrouping of bits represents a first number of two binary numbers;
assigning a second probability value for each of the plurality of subgroupings of bits that compose the symbol, said second probability value indicative of a probability that the subgrouping of bits represents a second number of the two binary numbers;
selecting one probability value of the first and second probability values for each subgrouping that represents a digit of a symbol character of a symbol code employed in formation of the data message;
summing the probability values of the subgroupings to form a probability that the symbol represents each symbol character of the symbol code;
selecting the symbol character having the maximum probability that the symbol represents said symbol character of the symbol code; and
assigning the symbol value of said symbol character to the symbol.

32. The start pattern determination apparatus of claim 31 wherein the first and second probability values are heuristically determined for each possible bit combination of the subgroupings of bits.

33. The start pattern determination apparatus of claim 29 wherein the examining each symbol of the series of symbols to determine the symbol value each symbol comprises the steps of:
assigning one of the two binary numbers to a first sub-symbol of the symbol according to a maximum likelihood that said first sub-symbol is one of the two binary numbers; and
iteratively performing said assigning until each subsequent sub-symbol is assigned one of the two binary numbers.

34. The start pattern determination apparatus of claim 29 wherein the symbols are a four pulse position modulation.

35. The start pattern determination apparatus of claim 34 wherein sampling of each digit of the four pulse position modulation form subgroupings of bits of the symbol.

36. The start pattern determination apparatus of claim 35 wherein said sampling is at a sampling rate that is at least five times greater than a pulse position modulation clocking rate.

37. A data extraction apparatus within a data communication receiver to extract data symbols of a data message encoded within a signal received by said data communication receiver, said data extraction apparatus comprising:
a register in communication with telemetric device to receive series of symbols composed of a plurality of bits resulting from a sampling of a signal received by said digital communication receiver and upon receipt of said plurality of bits, adjust location of said bits within said register; and
a symbol evaluator in communication with said register to examine said plurality of bits to determine a data symbol value for said plurality of bits, said data symbol value indicating at least one data bit of said data message, wherein said symbol value being a most probable value of all possible symbol values.

38. The data extraction apparatus of claim 37 wherein the symbol evaluator examines each symbol of the series of symbols to determine the data symbol value of each symbol by the steps of:
assigning a first probability value for each of a plurality of subgroupings of bits that compose the symbol, said first probability value indicative of a probability that the subgrouping of bits represents a first number of two binary numbers;
assigning a second probability value for each of the plurality of subgroupings of bits that compose the symbol, said second probability value indicative of a probability that the subgrouping of bits represents a second number of the two binary numbers;
selecting one probability value of the first and second probability values for each subgrouping that represents a digit of a symbol character of a symbol code employed in formation of the data message;
summing the probability values of the subgroupings to form a probability that the symbol represents each symbol character of the symbol code;
selecting the symbol character having the maximum probability that the symbol represents said symbol character of the symbol code; and
assigning the symbol value of said symbol character to the symbol.

39. The data extraction apparatus of claim 38 wherein the first and second probability values are heuristically determined for each possible bit combination of the subgroupings of bits.

40. The data extraction apparatus of claim 37 wherein the symbol evaluator examines each symbol of the series of symbols to determine the data symbol value of each symbol by the steps of:
assigning one of the two binary numbers to a first sub-symbol of the symbol according to a maximum likelihood that said first sub-symbol is one of the two binary numbers; and
iteratively performing said assigning until each subsequent sub-symbol is assigned one of the two binary numbers.

41. The data extraction apparatus of claim 37 wherein the symbols are a four pulse position modulation.

42. The data extraction apparatus of claim 41 wherein sampling of each digit of the four pulse position modulation form subgroupings of bits of the symbol.

43. The data extraction apparatus of claim 42 wherein said sampling is at a sampling rate that is at least five times greater than a pulse position modulation clocking rate.

44. A method for receiving a digital data communication signal comprising the steps of:
repetitively sampling said signal;
retaining samples of said signal in a register;
collecting said samples to create a series of symbols composed of a plurality of bits resulting from the sampling of the signal;
adjusting location of said bits within said register; and
evaluating the plurality of bits to determine a symbol value for said plurality of bits, said symbol value including a synchronization value indicating a timing of said signal, a start value indicating a beginning of a data message, and a data value indicating at least one data bit of said data message, wherein said symbol value being a most probable value of all possible symbol values.

45. The method of claim 44 wherein evaluating the plurality of bits comprises the steps of:
examining a first series of symbols received by said register to establish synchronous lock with said signal;
examining a second series of symbols received by said register to determine the beginning of the data message; and
examining a third series of symbols received by said register to determine the data message.

46. The method of claim 45 wherein examining the first series of symbols to establish synchronous lock comprises the steps of:
a) examining the plurality of bits in said register to determine a first transition of a first symbol of said first series;
b) upon determining the first transition, evaluating said plurality of bits resident in said register to determine if said plurality has a synchronization value;
c) if said plurality of bits has a synchronization value, iteratively evaluating each of the subsequent symbols received by said register to determine that each of said symbols has a synchronization value;
wherein, if the iterative evaluating of each of the subsequent symbols is a synchronization value, the receiver is locked; and
wherein, if the iterative evaluating of any of the pluralities of bits is not a synchronization value, iterating steps a)-c) until the receiver is locked.

47. The method of claim 45 wherein examining the second series of symbols to determine the beginning of the data message comprises the steps of:
evaluating each of the second series of symbols received by said register to determine that each of said second series of symbols has a start value;
wherein, if any of said second series of symbols does not have the start value, evaluating said series of symbols received by said register to determine that the first series of symbols is received to again establish synchronous lock;
wherein, if the second series of symbols have the start value, the beginning of the message is established.

48. The method of claim 45 wherein the examining each symbol of the first, second, and third series of symbols to determine the symbol value of each symbol comprises the steps of:
assigning a first probability value for each of a plurality of subgroupings of bits that compose the symbol, said first probability value indicative of a probability that the subgrouping of bits represents a first number of two binary numbers;
assigning a second probability value for each of the plurality of subgroupings of bits that compose the symbol, said second probability value indicative of a probability that the subgrouping of bits represents a second number of the two binary numbers;
selecting one probability value of the first and second probability values for each subgrouping that represents a digit of a symbol character of a symbol code employed in formation of the data message;
summing the probability values of the subgroupings to form a probability that the symbol represents each symbol character of the symbol code;
selecting the symbol character having the maximum probability that the symbol represents said symbol character of the symbol code; and
assigning the symbol value of said symbol character to the symbol.

49. The method of claim 48 wherein the first and second probability values are heuristically determined for each possible bit combination of the subgroupings of bits.

50. The method of claim 45 wherein the examining each symbol of the first, second, and third series of symbols to determine the symbol value each symbol comprises the steps of:
assigning one of the two binary numbers to a first sub-symbol of the symbol according to a maximum likelihood that said first sub-symbol is one of the two binary numbers; and
iteratively performing said assigning until each subsequent sub-symbol is assigned one of the two binary numbers.

51. The method of claim 44 wherein the symbols are a four pulse position modulation.

52. The method of claim 51 wherein sampling of each digit of the four pulse position modulation form subgroupings of bits of the symbol.

53. The method of claim 52 wherein said sampling is at a sampling rate that is at least five times greater than a pulse position modulation clocking rate.

54. A method for synchronizing a digital data communication receiver to a received digital data signal comprising the steps of:
repetitively sampling said signal;
retaining samples of said signal in a register;
collecting said samples to create a series of symbols composed of a plurality of bits resulting from the sampling of the signal;
adjusting location of said bits within said register; and
evaluating the plurality of bits to determine a synchronization symbol value for said plurality of bits, said synchronization value indicating a timing of said signal, wherein said symbol value being a most probable value of all possible symbol values.

55. The method of claim 54 wherein evaluating the plurality of bits comprises the steps of:
examining a series of symbols received by said register to establish synchronous lock with said signal.

56. The method of claim 55 wherein examining the series of symbols to establish synchronous lock comprises the steps of:
a) examining the plurality of bits in said register to determine a first transition of a first symbol of said first series;
b) upon determining the first transition, evaluating said plurality of bits resident in said register to determine if said plurality has a synchronization value;
c) if said plurality of bits has a synchronization value, iteratively evaluating each of the subsequent symbols received by said register to determine that each of said symbols has a synchronization value;
wherein, if the iterative evaluating of each of the subsequent symbols is a synchronization value, the receiver is locked; and
wherein, if the iterative evaluating of any of the pluralities of bits is not a synchronization value, iterating steps a)-c) until the receiver is locked.

57. The method of claim 55 wherein the examining each symbol of the series of symbols to determine the synchronous symbol value of each symbol comprises the steps of:
assigning a first probability value for each of a plurality of subgroupings of bits that compose the symbol, said first probability value indicative of a probability that the subgrouping of bits represents a first number of two binary numbers;
assigning a second probability value for each of the plurality of subgroupings of bits that compose the symbol, said second probability value indicative of a probability that the subgrouping of bits represents a second number of the two binary numbers;
selecting one probability value of the first and second probability values for each subgrouping that represents a digit of a symbol character of a symbol code employed in formation of the data message;
summing the probability values of the subgroupings to form a probability that the symbol represents each symbol character of the symbol code;
selecting the symbol character having the maximum probability that the symbol represents said symbol character of the symbol code; and
assigning the symbol value of said symbol character to the symbol.

58. The method of claim 57 wherein the first and second probability values are heuristically determined for each possible bit combination of the subgroupings of bits.

59. The method of claim 55 wherein the examining each symbol of the series of symbols to determine the symbol value each symbol comprises the steps of:
assigning one of the two binary numbers to a first sub-symbol of the symbol according to a maximum likelihood that said first sub-symbol is one of the two binary numbers; and
iteratively performing said assigning until each subsequent sub-symbol is assigned one of the two binary numbers.

60. The method of claim 54 wherein the symbols are a four pulse position modulation.

61. The method of claim 60 wherein sampling of each digit of the four pulse position modulation form subgroupings of bits of the symbol.

62. The method of claim 61 wherein said sampling is at a sampling rate that is at least five times greater than a pulse position modulation clocking rate.

63. A method for detecting a start pattern of a message of a digital data communication signal comprising the steps of:
repetitively sampling said signal;
retaining samples of said signal in a register;
collecting said samples to create a series of symbols composed of a plurality of bits resulting from the sampling of the signal;
adjusting location of said bits within said register; and
evaluating the plurality of bits to determine a start symbol value for said plurality of bits, said a start value indicating a beginning of a data message, wherein said symbol value being a most probable value of all possible symbol values.

64. The method of claim 63 wherein evaluating the series of symbols to determine the beginning of the data message comprises the steps of:
evaluating each of the series of symbols received by said register to determine that each of said second series of symbols has a start value;
wherein, if any of said second series of symbols does not have the start value, evaluating said series of symbols received by said register to determine that the first series of symbols is received to again establish synchronous lock;
wherein, if the second series of symbols have the start value, the beginning of the message is established.

65. The method of claim 64 wherein the evaluating each symbol of the series of symbols to determine the start symbol value of each symbol comprises the steps of:
assigning a first probability value for each of a plurality of subgroupings of bits that compose the symbol, said first probability value indicative of a probability that the subgrouping of bits represents a first number of two binary numbers;
assigning a second probability value for each of the plurality of subgroupings of bits that compose the symbol, said second probability value indicative of a probability that the subgrouping of bits represents a second number of the two binary numbers;
selecting one probability value of the first and second probability values for each subgrouping that represents a digit of a symbol character of a symbol code employed in formation of the data message;
summing the probability values of the subgroupings to form a probability that the symbol represents each symbol character of the symbol code;
selecting the symbol character having the maximum probability that the symbol represents said symbol character of the symbol code; and
assigning the symbol value of said symbol character to the symbol.

66. The method of claim 65 wherein the first and second probability values are heuristically determined for each possible bit combination of the subgroupings of bits.

67. The method of claim 64 wherein the evaluating each symbol of the series of symbols to determine the symbol value each symbol comprises the steps of:
assigning one of the two binary numbers to a first sub-symbol of the symbol according to a maximum likelihood that said first sub-symbol is one of the two binary numbers; and
iteratively performing said assigning until each subsequent sub-symbol is assigned one of the two binary numbers.

68. The method of claim 63 wherein the symbols are a four pulse position modulation.

69. The method of claim 68 wherein sampling of each digit of the four pulse position modulation form subgroupings of bits of the symbol.

70. The method of claim 79 wherein said sampling is at a sampling rate that is at least five times greater than a pulse position modulation clocking rate.

71. A method for extracting a digital data message digital data communication signal comprising the steps of:
repetitively sampling said signal;
retaining samples of said signal in a register;
collecting said samples to create a series of symbols composed of a plurality of bits resulting from the sampling of the signal;
adjusting location of said bits within said register; and
evaluating the plurality of bits to determine a data symbol value for said plurality of bits, said data symbol value indicating at least one data bit of said data message, wherein said symbol value being a most probable value of all possible symbol values.

72. The method of claim 71 wherein the evaluating each symbol of the series of symbols to determine the data symbol value of each symbol comprises the steps of:
assigning a first probability value for each of a plurality of subgroupings of bits that compose the symbol, said first probability value indicative of a probability that the subgrouping of bits represents a first number of two binary numbers;
assigning a second probability value for each of the plurality of subgroupings of bits that compose the symbol, said second probability value indicative of a probability that the subgrouping of bits represents a second number of the two binary numbers;
selecting one probability value of the first and second probability values for each subgrouping that represents a digit of a symbol character of a symbol code employed in formation of the data message;
summing the probability values of the subgroupings to form a probability that the symbol represents each symbol character of the symbol code;
selecting the symbol character having the maximum probability that the symbol represents said symbol character of the symbol code; and
assigning the symbol value of said symbol character to the symbol.

73. The method of claim 72 wherein the first and second probability values are heuristically determined for each possible bit combination of the subgroupings of bits.

74. The method of claim 71 wherein the evaluating each symbol of the series of symbols to determine the data symbol value each symbol comprises the steps of:
assigning one of the two binary numbers to a first sub-symbol of the symbol according to a maximum likelihood that said first sub-symbol is one of the two binary numbers; and
iteratively performing said assigning until each subsequent sub-symbol is assigned one of the two binary numbers.

75. The method of claim 71 wherein the symbols are a four pulse position modulation.

76. The method of claim 75 wherein sampling of each digit of the four pulse position modulation form subgroupings of bits of the symbol.

77. The method of claim 76 wherein said sampling is at a sampling rate that is at least five times greater than a pulse position modulation clocking rate.

78. A program retention device containing program instruction code executable on at least one computing device for receiving a digital data communication signal, said program instruction code comprising the steps of:
repetitively sampling said signal;
retaining samples of said signal in a register;
collecting said samples to create a series of symbols composed of a plurality of bits resulting from the sampling of the signal;
adjusting location of said bits within said register; and
evaluating the plurality of bits to determine a symbol value for said plurality of bits, said symbol value including a synchronization value indicating a timing of said signal, a start value indicating a beginning of a data message, and a data value indicating at least one data bit of said data message, wherein said symbol value being a most probable value of all possible symbol values.

79. The program retention device of claim 78 wherein evaluating the plurality of bits comprises the steps of:
examining a first series of symbols received by said register to establish synchronous lock with said signal;
examining a second series of symbols received by said register to determine the beginning of the data message; and
examining a third series of symbols received by said register to determine the data message.

80. The program retention device of claim 79 wherein examining the first series of symbols to establish synchronous lock comprises the steps of:
a) examining the plurality of bits in said register to determine a first transition of a first symbol of said first series;
b) upon determining the first transition, evaluating said plurality of bits resident in said register to determine if said plurality has a synchronization value;
c) if said plurality of bits has a synchronization value, iteratively evaluating each of the subsequent symbols received by said register to determine that each of said symbols has a synchronization value;
wherein, if the iterative evaluating of each of the subsequent symbols is a synchronization value, the receiver is locked; and
wherein, if the iterative evaluating of any of the pluralities of bits is not a synchronization value, iterating steps a)-c) until the receiver is locked.

81. The program retention device of claim 79 wherein examining the second series of symbols to determine the beginning of the data message comprises the steps of:
evaluating each of the second series of symbols received by said register to determine that each of said second series of symbols has a start value;
wherein, if any of said second series of symbols does not have the start value, evaluating said series of symbols received by said register to determine that the first series of symbols is received to again establish synchronous lock;
wherein, if the second series of symbols have the start value, the beginning of the message is established.

82. The program retention device of claim 79 wherein the examining each symbol of the first, second, and third series of symbols to determine the symbol value of each symbol comprises the steps of:
assigning a first probability value for each of a plurality of sub-groupings of bits that compose the symbol, said first probability value indicative of a probability that the sub-grouping of bits represents a first number of two binary numbers;
assigning a second probability value for each of the plurality of sub-groupings of bits that compose the symbol, said second probability value indicative of a probability that the sub-grouping of bits represents a second number of the two binary numbers;
selecting one probability value for each sub-grouping that represents a digit of a symbol character of a symbol code employed in formation of the data message;
summing the probability values of the sub-groupings to form a probability that the symbol represents each symbol character of the symbol code;
selecting the symbol character having the maximum probability that the symbol represents said symbol character of the symbol code; and
assigning the symbol value of said symbol character to the symbol.

83. The program retention device of claim 82 wherein the first and second probability values are heuristically determined for each possible bit combination of the sub-groupings of bits.

84. The program retention device of claim 79 wherein the examining each symbol of the first, second, and third series of symbols to determine the symbol value each symbol comprises the steps of:
assigning one of the two binary numbers to a first sub-symbol of the symbol according to a maximum likelihood that said first sub-symbol is one of the two binary numbers; and
iteratively performing said assigning until each subsequent sub-symbol is assigned one of the two binary numbers.

85. The program retention device of claim 84 wherein the symbols are a four pulse position modulation.

86. The program retention device of claim 85 wherein sampling of each digit of the four pulse position modulation form sub-groupings of bits of the symbol.

87. The program retention device of claim 86 wherein said sampling is at a sampling rate that is at least five times greater than a pulse position modulation clocking rate.
